(19) United States
(12) Patent Application Publication
(10) Pub. No.: US 2016/0086352 A1
(43) Pub. Date: Mar. 24, 2016

(54) DATABASE-GUIDED METHOD FOR DETECTING A MINERAL LAYER FROM SEISMIC SURVEY DATA

(71) Applicant: Siemens Aktiengesellschaft, Munich (DE)

(72) Inventors: Neil Birkbeck, Santa Cruz, CA (US); Jingdan Zhang, Bellevue, WA (US); Shaohua Kevin Zhou, Plainsboro, NJ (US)

(21) Appl. No.: 14/490,749

(22) Filed: Sep. 19, 2014

(51) Int. Cl. G06T 7/60; G06K 9/62; G06T 5/00; G06T 17/05; G06T 15/08

(52) U.S. Cl. CPC G06T 7/602; G06T 17/05; G06T 15/08; G06T 5/009; G06K 9/6228; G06T 2200/04; G06T 2207/20048; G06T 2207/20081; G06T 2207/30181

(57) ABSTRACT

A method for detecting a mineral layer in seismic survey image data includes transforming the intensity of an unprocessed seismic survey image volume, wherein the seismic survey image volume comprises a 3-dimensional (3D) grid of voxels each associated with an intensity, wherein a contrast of the seismic survey image volume is enhanced, scanning the intensity transformed image voxel-by-voxel with a classifier to determine a probability of each voxel being associated with a mineral layer, and thresholding the voxel probabilities to yield a 3D binary image mask that corresponds to the seismic survey image volume, wherein each voxel of the binary image mask has a value indicative of whether the voxel is mineral or non-mineral.

### TECHNICAL FIELD

This disclosure is directed to methods and systems for analyzing seismic tomography imaging data to detect and extract layers of minerals, such as salt, from the data.

### DISCUSSION OF THE RELATED ART

Seismic tomography is a technique for imaging Earth's sub-surface characteristics in an effort to understand deep geologic structure. Seismometers record ground movements in the form of seismic waves resulting from earthquakes or controlled explosions. The seismic waves include compressional waves and shear waves, and measurements are made of the seismic waves passing through the Earth. The velocity of the compressional and shear waves depends on the rheology of the material through which they travel. The character of these measurements is then analyzed to make inferences regarding the density, chemical composition, and thermal structure of the materials through which such waves have passed. Gathering sufficient compressional and shear wave travel time measurements enables the construction of 3D images of earth's velocity structure. The image depicts where seismic waves were able to travel faster or slower based on the differing arrive times of the waves. Seismologists can use tomography to infer structures such as petroleum deposits or mineral layers. One exemplary, non-limiting mineral is salt. However, seismic images of salt layers can be noisy and present a challenge to interpret. Examples of seismic images of salt are presented in FIG. 1.

### SUMMARY

Exemplary embodiments of the disclosure as described herein are directed to database-guided methods for extracting a mineral layer from seismic survey data. A method according to an embodiment of the disclosure combines processing of an entire 3D image volume, not just 2D slices, with a machine learning framework to detect mineral layers in seismic survey data.

According to an embodiment of the disclosure, there is provided a method for detecting a mineral layer in seismic survey image data, including transforming the intensity of an unprocessed seismic survey image volume, wherein the seismic survey image volume comprises a 3-dimensional (3D) grid of voxels each associated with an intensity, wherein a contrast of the seismic survey image volume is enhanced, scanning the intensity transformed image voxel-by-voxel with a classifier to determine a probability of each voxel being associated with a mineral layer, and thresholding the voxel probabilities to yield a 3D binary image mask that corresponds to the seismic survey image volume, wherein each voxel of the binary image mask has a value indicative of whether the voxel is mineral or non-mineral.

According to a further embodiment of the disclosure, the mineral is salt.

According to a further embodiment of the disclosure, the probability of each voxel being associated with a mineral layer is a values in the range (−1, 1), wherein a positive value indicates that the voxel is probably associated with the mineral layer, and a negative value otherwise, and wherein a absolute value of the probability represents a confidence in the classification.

According to a further embodiment of the disclosure, the classifier is a boosting classifier trained using a database of image pairs, wherein each image pair includes an intensity-transformed seismic survey image volume and a binary image mask corresponding to the intensity-transformed seismic survey image volume.

According to a further embodiment of the disclosure, the classifier is trained using a plurality of rectangular features, and wherein the training selects those rectangular features that can best discriminate the mineral layer from the non-mineral regions of the intensity-transformed seismic survey image volume.

According to a further embodiment of the disclosure, scanning the intensity transformed image voxel-by-voxel includes examining a local 3D neighborhood centered around a voxel of interest.

According to a another embodiment of the disclosure, there is provided a method for detecting a mineral layer in seismic survey image data, including providing a database of 3-dimensional (3D) image pairs, wherein each pair includes a seismic survey image volume and a binary image mask corresponding to the seismic survey image volume, wherein each voxel of the binary image mask has a value indicative of whether the voxel is in a mineral layer, wherein each image comprises a 3D grid of voxels each associated with an intensity, training a classifier to detect a mineral layer in a seismic survey image volume using a boosting algorithm that uses the database of 3D image pairs, and using the classifier to detect a mineral layer in a new seismic survey image volume.

According to a further embodiment of the disclosure, the seismic survey image volume in each pair of images in the database of 3D image pairs in intensity transformed to enhance image contrast.

According to a further embodiment of the disclosure, the classifier is trained using a plurality of rectangular features, and wherein the training selects those rectangular features that can best discriminate the mineral layer from the non-mineral regions of the intensity-transformed seismic survey image volume.

According to a further embodiment of the disclosure, the mineral is salt.

According to a further embodiment of the disclosure, using the classifier to detect a mineral layer in a new seismic survey image volume includes transforming the intensity of an unprocessed seismic survey image volume, wherein a contrast of the seismic survey image volume is enhanced, scanning the intensity transformed image voxel-by-voxel with the classifier to determine a probability of each voxel being associated with the mineral layer, and thresholding the voxel probabilities to yield a 3D binary image mask that corresponds to the seismic survey image volume, wherein each voxel of the binary image mask has a value indicative of whether the voxel is mineral or non-mineral.

According to a further embodiment of the disclosure, the probability of each voxel being associated with a mineral layer is a value in the range (−1, 1), wherein a positive value indicates that the voxel is probably associated with the mineral layer, and a negative value otherwise, and wherein a absolute value of the probability represents a confidence in the classification.

According to a further embodiment of the disclosure, scanning the intensity transformed image voxel-by-voxel includes examining a local 3D neighborhood centered around a voxel of interest.

According to a another embodiment of the disclosure, there is provided a non-transitory program storage device readable by a computer, tangibly embodying a program of instructions executed by the computer to perform the method steps for detecting a mineral layer in seismic survey image data.

### BRIEF DESCRIPTION OF THE DRAWINGS

FIG. 1 depicts several examples of seismic survey images of salt layers, according to an embodiment of the disclosure.

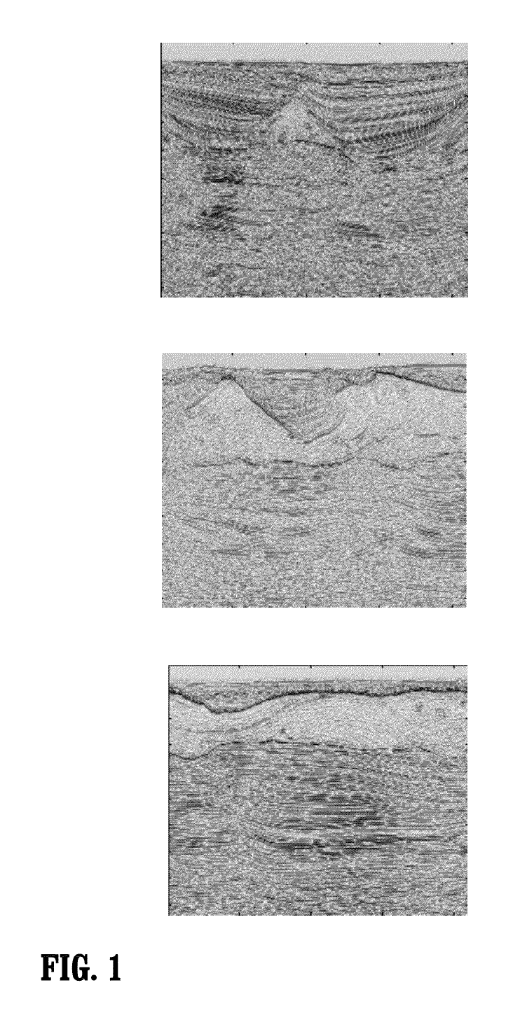

FIGS. 2A-C illustrates a conventional method of detecting a salt layer in seismic survey data, according to an embodiment of the disclosure.

FIGS. 3A-d illustrates a data-base guided method of detecting a salt layer in seismic survey data, according to an embodiment of the disclosure.

FIG. 4 illustrates an example of a multi-planar reformatted image of a seismic survey image volume that has been classified according to a probability of its voxels being salt or on-salt, according to an embodiment of the disclosure.

FIG. 5 is a receiver operating characteristic curve of the performance of a classifier according to an embodiment of the disclosure.

FIG. 6 is a block diagram of an exemplary computer system for implementing a method for a database-guided detection of a mineral layer from seismic survey data, according to an embodiment of the disclosure.

### DETAILED DESCRIPTION OF EXEMPLARY EMBODIMENTS

Exemplary embodiments of the disclosure as described herein generally include systems and methods for a database-guided detection of a mineral layer from seismic survey data. Accordingly, while the disclosure is susceptible to various modifications and alternative forms, specific embodiments thereof are shown by way of example in the drawings and will herein be described in detail. It should be understood, however, that there is no intent to limit the disclosure to the particular forms disclosed, but on the contrary, the disclosure is to cover all modifications, equivalents, and alternatives falling within the spirit and scope of the disclosure.

As used herein, the term “image” refers to multi-dimensional data composed of discrete image elements (e.g., pixels for 2-D images and voxels for 3-D images). The image may be, for example, a medical image of a subject collected by computer tomography, magnetic resonance imaging, ultrasound, or any other medical imaging system known to one of skill in the art. The image may also be provided from non-medical contexts, such as, for example, remote sensing systems, electron microscopy, etc. Although an image can be thought of as a function from R³ to R or R⁷, methods of embodiments of the disclosure are not limited to such images, and can be applied to images of any dimension, e.g., a 2-D picture or a 3-D volume. For a 2- or 3-dimensional image, the domain of the image is typically a 2- or 3-dimensional rectangular array, wherein each pixel or voxel can be addressed with reference to a set of 2 or 3 mutually orthogonal axes. The terms “digital” and “digitized” as used herein will refer to images or volumes, as appropriate, in a digital or digitized format acquired via a digital acquisition system or via conversion from an analog image.

Embodiments of the present disclosure for detecting mineral layers in seismic survey data will be described using salt as an exemplary, non-limiting mineral. However, it is to be understood that methods according to embodiments of the disclosure can be applied to the detection of layers of other minerals in seismic survey data.

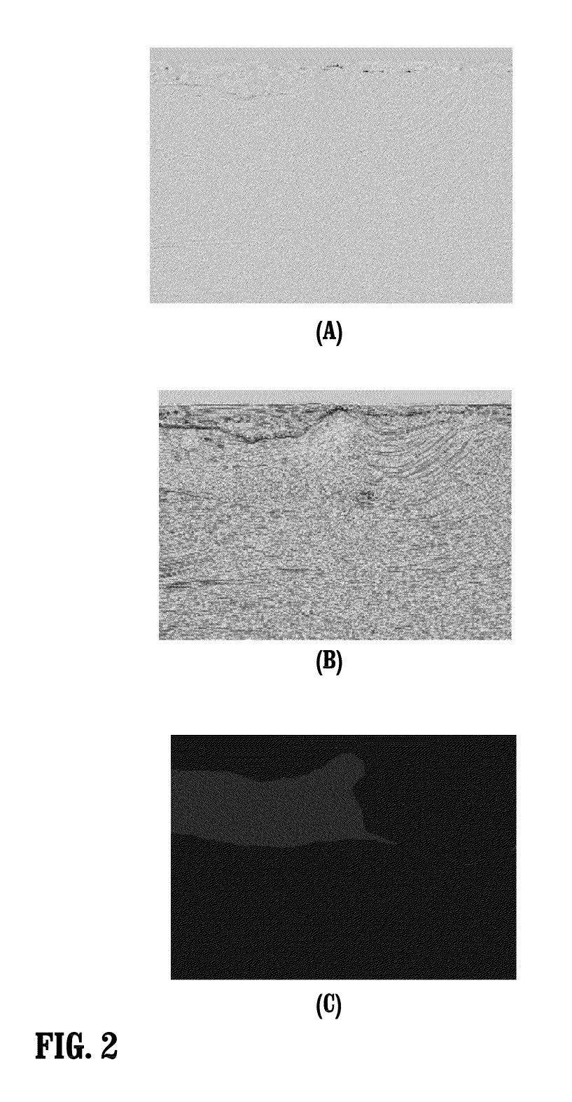

FIGS. 2A-C illustrates a conventional method of detecting a salt layer in seismic survey data. Although seismic survey data is 3D image volumes, FIGS. 2A-C shows 2D slices from the 3D data. A typical, raw, unprocessed seismic survey image, such as that shown in FIG. 2A, is a 3D image volume whose intensity values are close to being saturated. A typical image can have on the order of 10⁸ or more voxels. However, such an image has intensity variations that are undetectable to the human eye. An intensity transformation, such as a logarithmic transformation, can be applied to the raw image data to increase the image contrast by magnifying these intensity variations. The result of such a transformation is depicted in FIG. 2B. As may be seen, the intensity transformed image is quite noisy, which obscures the presence of structures, such as a salt layer. The transformed image may then be analyzed and annotated by an expert, who can identify the desired salt layer in the image. The annotated image can then be transformed into a binary image mask, depicted in FIG. 2C, which shows a salt layer 21 against a background 20, which is everything else.

According to an embodiment of the disclosure, a database of pairs of images, in which each pair comprises an intensity transformed image and its corresponding binary mask, can be used to train a classifier that can detect a salt layer in a previously unseen image. A database according to an embodiment of the disclosure may contain thousands of image pairs. A classifier according to an embodiment of the disclosure takes as input the intensity values of a voxel and its neighboring voxels in a seismic survey image, and outputs a probability of that voxel being in a salt layer. Exemplary, non-limiting algorithms for training a classifier include Probabilistic Boosting Tree (PBT) and AdaBoost, or Adaptive Boosting, which is a particular method of training a boosted classifier.

A boost classifier is a classifier of the form

F_{T}(x)=Σₜ₌₁^{T}fₜ(x),

where each fₜ is a weak learner that takes an object x as its input and returns a real valued result indicating the class of the object. The sign of the weak learner output identifies the predicted object class and the absolute value gives the confidence in that classification. Similarly, the combined classifier F_{T} will be positive if the sample is believed to be in the positive class and negative otherwise.

Each weak learner produces an output, a hypothesis h(xᵢ) for each sample in the training set. At each iteration t, a weak learner is selected and assigned a weight coefficient αₜ such that the sum of training errors Eₜ of the resulting f-stage boost classifier is minimized:

Eₜ=ΣᵢE[Fₜ₋₁(xᵢ)+αₜh(xᵢ)],

Here, Fₜ₋₁(xᵢ) is the boosted classifier that has been built up to the previous stage of training, E(F) is an error function and fₜ(x)=αₜh(x) is the weak learner that is being considered for addition to the final classifier A classifier according to an embodiment of the disclosure uses a plurality of 3D rectangular features to train the classifier, and the training process can select those rectangular features that can best discriminate the salt layer from non-salt regions.

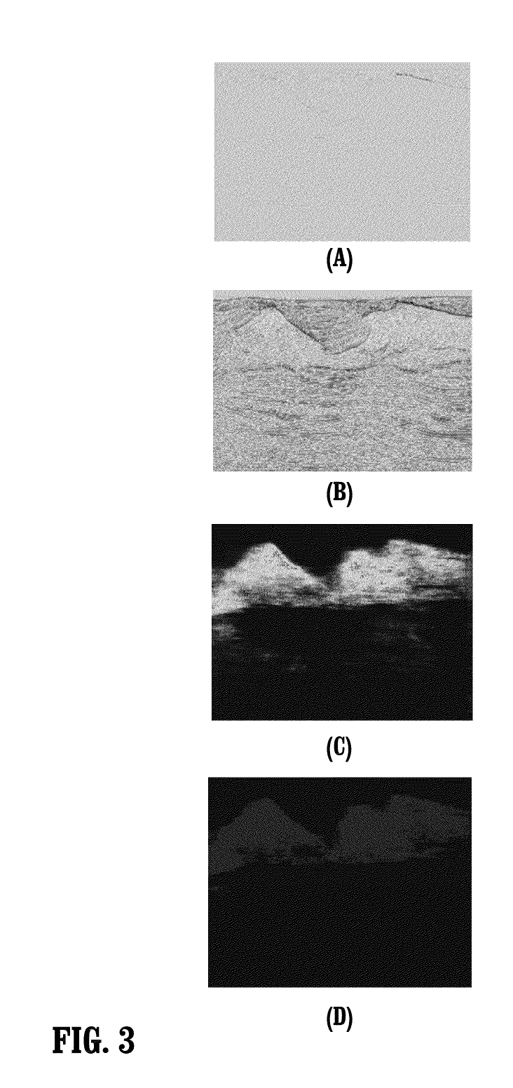

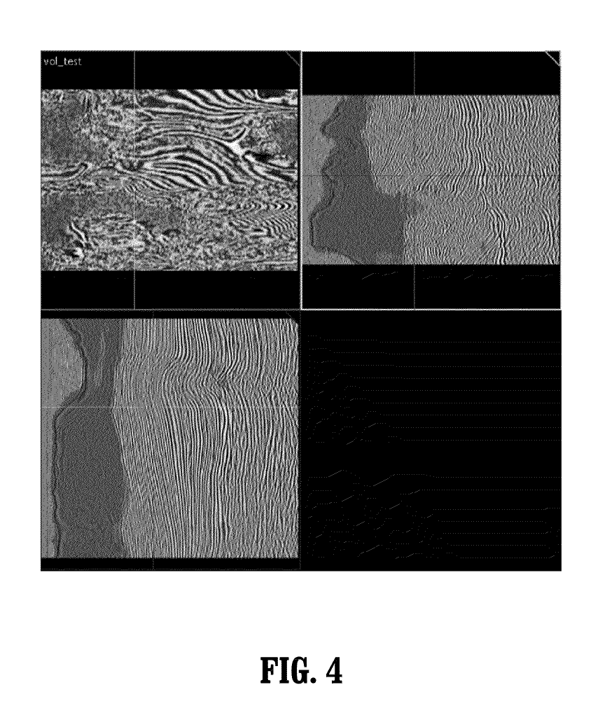

A method according to an embodiment of the disclosure for using a trained classifier to detect a salt layer in seismic survey data is as follows, with reference to FIGS. 3A-D. FIGS. 3A-D show 2D slices extracted from the 3D survey data. The intensity of a raw, unprocessed survey image volume, such as that shown in FIG. 3A, is transformed as described above to enhance image contrast, a result of which is shown in FIG. 3B. The transformed image is then scanned voxel-by-voxel by the classifier F_{T}, which yields a probability of each voxel of being a salt voxel. According to an embodiment of the disclosure, during the voxel-by-voxel scanning, a local 3D neighborhood centered around the voxel of interest is used as input to the classifier. The local neighborhood is small as compared to the overall size of the image volume being scanned. The classified result may be displayed as a false color image, such as that shown in FIG. 3C, in which the brighter voxels 33 have a higher probability of being salt, and the darker pixels 34 have lower probability of being salt. The classified result may be subject to a probability threshold to define a binary image mask from the survey data, in which each voxel is classified as either salt 35 or non-salt (background) 36, as shown in FIG. 3D. An exemplary, non-limiting probability threshold is 0.50 (50%). In addition, since the classified result image is a 3D image volume, it may be thought of as a stack of 2D slices. Image processing software may then be used to cuts slices through the volume in different planes, a technique known as multi-planar reconstruction (MPR). Although these slices may usually be orthogonal, they may also be at oblique angles so that the slices are non-orthogonal. An example of a multi-planar reformatted classified image result is shown in FIG. 4. These classified image results and binary image masks may be used to physically locate a salt layer from the seismic survey so that the salt layer may be physically extracted from the Earth.

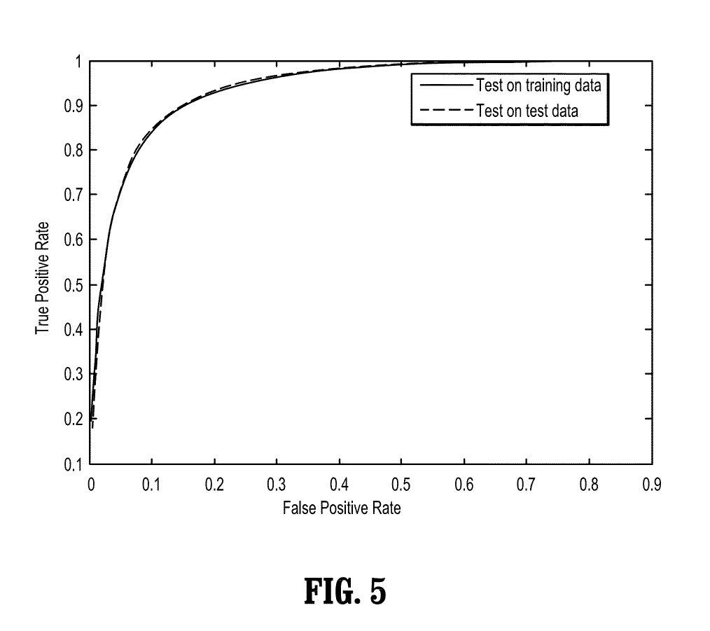

A method according to an embodiment of the disclosure was tested on a data set of 1876×841×151 voxels. The data set was divided along a y-axis to define a 1876×421×151 training data set and a 1876×420×151 testing data set. After the classifier was trained on the training data set, it was tested using both the training data set and the testing data set. The receiver operating characteristic curve, which is shown in FIG. 5, illustrates the performance of a classifier according to an embodiment of the disclosure as its discrimination threshold is varied. A classifier according to an embodiment of the disclosure generalizes well, with little or no over-fitting.

It is to be understood that embodiments of the present disclosure can be implemented in various forms of hardware, software, firmware, special purpose processes, or a combination thereof. In one embodiment, the present disclosure can be implemented in software as an application program tangible embodied on a computer readable program storage device. The application program can be uploaded to, and executed by, a machine comprising any suitable architecture.

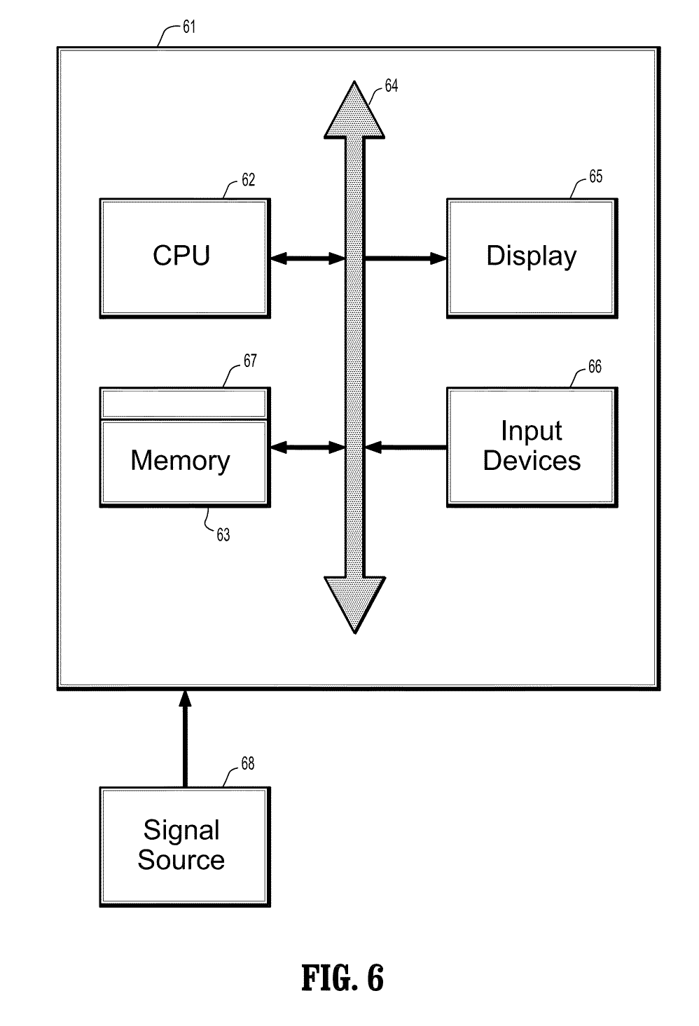

FIG. 6 is a block diagram of an exemplary computer system for implementing a method for a database-guided detection of a mineral layer from seismic survey data, according to an embodiment of the disclosure. Referring now to FIG. 6, a computer system 61 for implementing the present disclosure can comprise, inter alia, a central processing unit (CPU) 62, a memory 63 and an input/output (I/O) interface 64. The computer system 61 is generally coupled through the I/O interface 64 to a display 65 and various input devices 66 such as a mouse and a keyboard. The support circuits can include circuits such as cache, power supplies, clock circuits, and a communication bus. The memory 63 can include random access memory (RAM), read only memory (ROM), disk drive, tape drive, etc., or a combinations thereof. The present disclosure can be implemented as a routine 67 that is stored in memory 63 and executed by the CPU 62 to process the signal from the signal source 68. As such, the computer system 61 is a general purpose computer system that becomes a specific purpose computer system when executing the routine 67 of the present disclosure.

The computer system 61 also includes an operating system and micro instruction code. The various processes and functions described herein can either be part of the micro instruction code or part of the application program (or combination thereof) which is executed via the operating system. In addition, various other peripheral devices can be connected to the computer platform such as an additional data storage device and a printing device.

It is to be further understood that, because some of the constituent system components and method steps depicted in the accompanying figures can be implemented in software, the actual connections between the systems components (or the process steps) may differ depending upon the manner in which the present disclosure is programmed. Given the teachings of the present disclosure provided herein, one of ordinary skill in the related art will be able to contemplate these and similar implementations or configurations of the present disclosure.

While the present disclosure has been described in detail with reference to exemplary embodiments, those skilled in the art will appreciate that various modifications and substitutions can be made thereto without departing from the spirit and scope of the disclosure as set forth in the appended claims.

What is claimed is:

1. A method for detecting a mineral layer in seismic survey image data, comprising the steps of:
transforming the intensity of an unprocessed seismic survey image volume, wherein said seismic survey image volume comprises a 3-dimensional (3D) grid of voxels each associated with an intensity, wherein a contrast of the seismic survey image volume is enhanced;
scanning the intensity transformed image voxel-by-voxel with a classifier to determine a probability of each voxel being associated with a mineral layer; and
thresholding the voxel probabilities to yield a 3D binary image mask that corresponds to the seismic survey image volume, wherein each voxel of the binary image mask has a value indicative of whether the voxel is mineral or non-mineral.

2. The method of claim 1, wherein the mineral is salt.

3. The method of claim 1, wherein the probability of each voxel being associated with a mineral layer is a value in the range (−1, 1), wherein a positive value indicates that the voxel is probably associated with the mineral layer, and a negative value otherwise, and wherein a absolute value of the probability represents a confidence in the classification.

4. The method of claim 1, wherein the classifier is a boosting classifier trained using a database of image pairs, wherein each image pair includes an intensity-transformed seismic survey image volume and a binary image mask corresponding to the intensity-transformed seismic survey image volume.

5. The method of claim 4, wherein the classifier is trained using a plurality of rectangular features, and wherein the training selects those rectangular features that can best discriminate the mineral layer from the non-mineral regions of the intensity-transformed seismic survey image volume.

6. The method of claim 1, wherein scanning the intensity transformed image voxel-by-voxel includes examining a local 3D neighborhood centered around a voxel of interest.

7. A method for detecting a mineral layer in seismic survey image data, comprising the steps of:
providing a database of 3-dimensional (3D) image pairs, wherein each pair includes a seismic survey image volume and a binary image mask corresponding to the seismic survey image volume, wherein each voxel of the binary image mask has a value indicative of whether the voxel is in a mineral layer, wherein each said image comprises a 3D grid of voxels each associated with an intensity;
training a classifier to detect a mineral layer in a seismic survey image volume using a boosting algorithm that uses the database of 3D image pairs; and
using the classifier to detect a mineral layer in a new seismic survey image volume.

8. The method of claim 7, wherein the seismic survey image volume in each pair of images in the database of 3D image pairs in intensity transformed to enhance image contrast.

9. The method of claim 7, wherein the classifier is trained using a plurality of rectangular features, and wherein the training selects those rectangular features that can best discriminate the mineral layer from the non-mineral regions of the intensity-transformed seismic survey image volume.

10. The method of claim 7, wherein the mineral is salt.

11. The method of claim 7, wherein using the classifier to detect a mineral layer in a new seismic survey image volume comprises:
transforming the intensity of an unprocessed seismic survey image volume, wherein a contrast of the seismic survey image volume is enhanced;
scanning the intensity transformed image voxel-by-voxel with the classifier to determine a probability of each voxel being associated with the mineral layer; and
thresholding the voxel probabilities to yield a 3D binary image mask that corresponds to the seismic survey image volume, wherein each voxel of the binary image mask has a value indicative of whether the voxel is mineral or non-mineral.

12. The method of claim 11, wherein the probability of each voxel being associated with a mineral layer is a value in the range (−1, 1), wherein a positive value indicates that the voxel is probably associated with the mineral layer, and a negative value otherwise, and wherein a absolute value of the probability represents a confidence in the classification.

13. The method of claim 11, wherein scanning the intensity transformed image voxel-by-voxel includes examining a local 3D neighborhood centered around a voxel of interest.

14. A non-transitory program storage device readable by a computer, tangibly embodying a program of instructions executed by the computer to perform the method steps for detecting a mineral layer in seismic survey image data, the method comprising the steps of:
providing a database of 3-dimensional (3D) image pairs, wherein each pair includes a seismic survey image volume and a binary image mask corresponding to the seismic survey image volume, wherein each voxel of the binary image mask has a value indicative of whether the voxel is in a mineral layer, wherein each said image comprises a 3D grid of voxels each associated with an intensity;
training a classifier to detect a mineral layer in a seismic survey image volume using a boosting algorithm that uses the database of 3D image pairs; and
using the classifier to detect a mineral layer in a new seismic survey image volume.

15. The computer readable program storage device of claim 14, wherein the seismic survey image volume in each pair of images in the database of 3D image pairs in intensity transformed to enhance image contrast.

16. The computer readable program storage device of claim 14, wherein the classifier is trained using a plurality of rectangular features, and wherein the training selects those rectangular features that can best discriminate the mineral layer from the non-mineral regions of the intensity-transformed seismic survey image volume.

17. The computer readable program storage device of claim 14, wherein the mineral is salt.

18. The computer readable program storage device of claim 14, wherein using the classifier to detect a mineral layer in a new seismic survey image volume comprises:
transforming the intensity of an unprocessed seismic survey image volume, wherein a contrast of the seismic survey image volume is enhanced;
scanning the intensity transformed image voxel-by-voxel with the classifier to determine a probability of each voxel being associated with the mineral layer; and
thresholding the voxel probabilities to yield a 3D binary image mask that corresponds to the seismic survey image volume, wherein each voxel of the binary image mask has a value indicative of whether the voxel is mineral or non-mineral.

19. The computer readable program storage device of claim 18, wherein the probability of each voxel being associated with a mineral layer is a values in the range (−1, 1), wherein a positive value indicates that the voxel is probably associated with the mineral layer, and a negative value otherwise, and wherein a absolute value of the probability represents a confidence in the classification.

20. The computer readable program storage device of claim 18, wherein scanning the intensity transformed image voxel-by-voxel includes examining a local 3D neighborhood centered around a voxel of interest.
